(19) United States
(12) Patent Application Publication
(10) Pub. No.: US 2026/0162155 A1
(43) Pub. Date: Jun. 11, 2026

(54) STOCHASTIC RANK BOOST FACTORS TO OPTIMIZE ENGAGEMENT AND REVENUE

(71) Applicant: ROKU, INC., San Jose, CA (US)

(72) Inventors: Fei XIAO, San Jose, CA (US); Pulkit AGGARWAL, San Jose, CA (US); Zidong WANG, San Jose, CA (US); Daniel MEROPOL, Brooklyn, CA (US); Abhishek BAMBHA, Burlingame, CA (US); Atishay JAIN, Mountain View, CA (US); Nam VO, San Jose, CA (US); Ronica JETHWA, Mountain View, CA (US); Jose SANCHEZ, San Jose, CA (US); Lian LIU, Rancho Palos Verdes, CA (US); Unnikrishnan R. NAIR, Bangalore (IN); Amit VERMA, Sunnyvale, CA (US); Rohit MAHTO, San Jose, CA (US); Aasish SIPANI, Danville, CA (US)

(73) Assignee: ROKU, INC., San Jose, CA (US)

(21) Appl. No.: 18/973,485

(22) Filed: Dec. 9, 2024

(51) Int. Cl. G06Q 30/0282

(52) U.S. Cl. CPC G06Q 30/0282

(57) ABSTRACT

Disclosed herein are system, method and/or computer program product embodiments, and/or combinations thereof, for stochastic multi-period multi-objective optimization based recommendation system. An embodiment assigns a respective plurality of stochastic parameters to a plurality of recommendation objectives. The embodiment further associates each program of a plurality of programs with one or more recommendation objectives of the plurality of recommendation objectives, and selects, during a first recommendation time period, a first set of operative recommendation objectives from the plurality of recommendation objectives based on the plurality of stochastic parameters. The embodiment then generates a first ordered list of recommended programs from the plurality of programs based on the first set of operative recommendation objectives. The embodiment dynamically reorganizes, during the first recommendation time period, programs displayed on a graphical user interface (GUI) based on the first ordered list of recommended programs.

### BACKGROUND

### Field

This disclosure is generally directed to multi-objective optimizing recommendation systems, and more particularly to recommendation systems based on stochastic multi-period multi-objective optimization (MPMOO) with stochastic rank boosting.

### SUMMARY

Provided herein are system, apparatus, article of manufacture, method and/or computer program product embodiments, and/or combinations and sub-combinations thereof, for generating an ordered list of recommended programs using stochastic multi-period multi-objective optimization (MPMOO) based recommendation system. An improvement provided by the stochastic MPMOO based recommendation system is that it enables balancing conflicting recommendation objectives over time. Also, since stochastic MPMOO based recommendation systems optimizes a limited number of recommendation objectives over each time period of operation, they do not experience scalability issues. Furthermore, stochastic MPMOO based recommendation system improves the overall utilization of network resources by dynamically adjusting to varying user demands, traffic patterns, and content types resulting in a balanced network resource allocation.

Some aspects of this disclosure relate to a method for generating ordered list of recommended programs using stochastic MPMOO based recommendation systems. According to some aspects, the method includes assigning a respective plurality of stochastic parameters to a plurality of recommendation objectives, and associating each program of a plurality of programs with one or more recommendation objectives of the plurality of recommendation objectives. According to some aspects, during a first recommendation time period, a first set of operative recommendation objectives are selected from the plurality of recommendation objectives based on the plurality of stochastic parameters. A first ordered list of recommended programs are then generated from the plurality of programs based on the first set of operative recommendation objectives. According to some aspect, during the first recommendation time period, programs displayed on a graphical user interface (GUI) are dynamically reorganized, based on the first ordered list of recommended programs.

### BRIEF DESCRIPTION OF THE FIGURES

The accompanying drawings are incorporated herein and form a part of the specification.

FIG. 1 illustrates a block diagram of a multimedia environment, according to some embodiments.

FIG. 2 illustrates a block diagram of a streaming media device, according to some embodiments.

FIG. 3 illustrates an example GUI displaying ordered lists of recommended programs generated by a stochastic MPMOO based recommendation system over multiple time periods, according to some embodiments.

FIG. 4 illustrates a flow diagram of a method for generating ordered lists of recommended programs using a stochastic MPMOO based recommendation system, according to some embodiments.

FIG. 5 illustrates a flow diagram of a method for generating an ordered list of recommended programs using a stochastic MPMOO based recommendation system with stochastic rank boosting, according to some embodiments.

FIG. 6 illustrates a flow diagram of a method for generating an ordered list of recommended programs using a stochastic MPMOO based recommendation system with ranking based on a stochastic cumulative score, according to some embodiments.

FIG. 7 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, article of manufacture, method and/or computer program product embodiments, and/or combinations and sub-combinations thereof, for optimizing recommendation systems using stochastic multi-period multi-objective optimization (MPMOO). For example, aspects herein describe a stochastic MPMOO based recommendation system using a different objective function for each time period of operation. The stochastic MPMOO based recommendation system can generate an ordered list of recommended programs, over each time period, based on a stochastically selected set operative objectives functions and the recommendation objectives associated with each program.

A content recommendation system analyzes user data and available content characteristics to suggest relevant programs to users. These programs can include multimedia content such as music, videos, movies, TV programs, multimedia, gaming applications, advertisements, programming content, public service content, government content, local community content, software, and/or the like.

Prior art systems typically relied on a deterministic approach for identifying and transmitting content recommendations to user systems. A deterministic approach involves using fixed rules or formulas for this step which means that, given the same inputs, this approach will produce the same output. This can be problematic for content delivery and recommendation for a number of reasons. One problem is that popular content can cause overwhelming demand on specific servers (because the same content is being recommended) leading to server overloads. Another problem is recommendation fault tolerance where a deterministic approach which results in suboptimal recommendations will continue to produce suboptimal recommendations.

A stochastic MPMOO approach solves these technical issues. A stochastic MPMOO system can distribute user requests over a wider range of content to reduce demand on caches, allowing more content to be cached efficiently which improves cache hit rates and reducing server load. This is contrast to deterministic systems where a small number of popular content can dominate a cache which could reduce cache hit rates. Introducing stochastic boosting techniques to content recommendation also improves load balancing and bandwidth optimization. Where a deterministic approach can cause user requests to be concentrated to popular content (leading to uneven loads across the content delivery system), stochastic boosting can improve the ability of the system to distribute user requests across different content servers which can reduce network latency. This can also result in content requests being directed across the content delivery system, instead of at specific servers, which can optimize bandwidth usage.

The stochastic MPMOO system of this disclosure also can be adjusted based on contextual factors. Where a deterministic approach may be locked into a specific formula, contextual factors such as current time, user viewing habits, user location, specific events, may be incorporated into the stochastic MPMOO system for dynamically adjusting content delivery, making the system more adaptive and responsive to user behavior or network conditions.

In some embodiments, the content recommendation system can be implemented in a proprietary multimedia environment that runs a proprietary media operating system. Installed in the media system and managed by the media operating system may be multiple streaming applications, with each streaming application configured to provide access to separate streaming servers. In some embodiments, one or more of the streaming applications may also be proprietary, which means that user interactions within a proprietary streaming application may be prevented from being shared with the proprietary media operating system such that the media operating system does not have access to streaming data by each streaming application. Streaming applications may provide limited visibility into content items that are provided by each streaming application. The media operating system may utilize the limited visibility to provide access to those content items in the streaming applications such as using a search function provided by the media operating system. For example, the search function, which may be text or voice-based, may allow a user to search for content items. Media operating system may provide search results that include any streaming applications that provide the content item. Media operating system may provide access to the streaming applications that have the requested content item. Media operating system may track user interactions with the media operating system including all interactions that occur outside of the streaming applications, such as the user's search history and user's watch history with any applications that are also controlled and managed by the same entity that provides the media operating system.

Content recommendation systems aim to provide users with personalized and relevant content (e.g., movies, articles, products, etc.) based on their preferences, past behavior, and context. These systems use optimization algorithms to generate a recommended list of programs that a user is most likely to engage with or find valuable. The optimization algorithms may optimize multiple objectives such as maximizing user engagement, maximizing user satisfaction or relevance, maximizing long-term user retention, revenue maximization, minimizing content fatigue, bias mitigation, and/or the like.

Multi-objective recommendation systems generally aim to balance multiple, often competing, goals over a single time period. While these systems have the potential to provide more balanced recommendations, they also introduce several inefficiencies and challenges. For example, balancing multiple objectives, such as maximizing user engagement and maximizing revenue, may conflict with each other. Furthermore, programs that can increase revenue (e.g., content that requires additional subscriptions) may reduce user engagement, and it may not be possible to improve one objective without sacrificing another over a single time period. As multi-objective recommendation systems become more complex, they can face scalability challenges. Adding more objectives to the optimization process increases the computational load, which can slow down real-time recommendations, especially as the multimedia content delivery system and its user base grow. The more objectives included, the harder it is to scale the system efficiently while maintaining acceptable performance and recommendation quality across a large number of users and content items simultaneously.

Furthermore, when optimizing over multiple conflicting objectives, using the same multi-objective optimization function across multiple time periods to generate lists of recommended programs may result in inefficient resource utilization. For example, estimating the amount of computational or data resources that should be allocated to each of the conflicting objectives can be a challenge. Misallocation of resources can lead to reduced system performance or the dominance of one objective over others, reducing the overall effectiveness of the system and can result in inefficient use of network bandwidth when delivering personalized content to many users simultaneously.

Embodiments herein address the above issues by presenting techniques and mechanisms for generating an ordered list of recommended programs using a stochastic multi-period multi-objective optimization (MPMOO) based recommendation system. A stochastic MPMOO based recommendation system can use a different objective function for each time period of operation, and determines a different ordered list of recommended programs during each time period of operation, instead of using a single objective function over multiple time periods of operation. Using stochastic MPMOO based recommendation system enables balancing conflicting recommendation objectives over time. Also, since stochastic MPMOO based recommendation systems optimizes a limited number of recommendation objectives over each time period of operation, they do not experience scalability issues. Furthermore, stochastic MPMOO based recommendation system can improve the overall utilization of network resources by dynamically adjusting to varying user demands, traffic patterns, and content types, resulting in a more balanced network resource allocation.

According to some aspects, for each time period, the stochastic MPMOO based recommendation system generates an ordered list of recommended programs. According to some aspects, each recommendation objective from the designated set of recommendation objectives is assigned a respective plurality of stochastic parameters, and each available program is associated with one or more recommendation objectives. During a given time period of operation, a first set of operative recommendation objectives is selected from the plurality of recommendation objectives based on the stochastic parameters. The stochastic MPMOO based recommendation system generates an ordered list of recommended programs set of operative recommendation objectives, and the programs displayed on a graphical user interface (GUI) of a media device are dynamically reorganized based on the first ordered list of recommended programs. Dynamically reorganizing the display of programs on a GUI based on the ordered lists of recommended programs allows the content recommendation system to continuously adapt and deliver a seamless user experience.

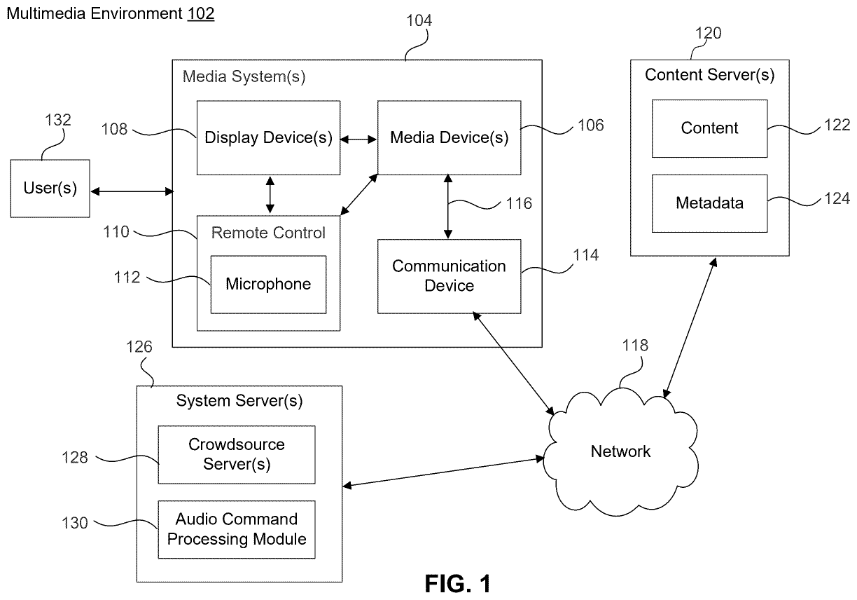

Various aspects of this disclosure may be implemented using and/or may be part of a multimedia environment 102 shown in FIG. 1. It is noted, however, that multimedia environment 102 is provided solely for illustrative purposes, and is not limiting. Embodiments of this disclosure may be implemented using and/or may be part of environments different from and/or in addition to the multimedia environment 102, as will be appreciated by persons skilled in the relevant art(s) based on the teachings contained herein. An example of the multimedia environment 102 shall now be described.

### Multimedia Environment

FIG. 1 illustrates a block diagram of a multimedia environment 102, according to some embodiments. In a non-limiting example, multimedia environment 102 may be directed to streaming media. However, this disclosure is applicable to any type of media (instead of or in addition to streaming media), as well as any mechanism, means, protocol, method and/or process for distributing media.

Multimedia environment 102 may include one or more media systems 104. A media system 104 could represent a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play streaming content. User(s) 132 may operate with the media system 104 to select and consume content.

Each media system 104 may include one or more media devices 106 each coupled to one or more display devices 108. It is noted that terms such as “coupled,” “connected to,” “attached,” “linked,” “combined” and similar terms may refer to physical, electrical, magnetic, logical, etc., connections, unless otherwise specified herein.

Media device 106 may be a streaming media device, DVD or BLU-RAY device, audio/video playback device, cable box, and/or digital video recording device, to name just a few examples. Display device 108 may be a monitor, television (TV), computer, smart phone, tablet, wearable (such as a watch or glasses), appliance, internet of things (IoT) device, and/or projector, to name just a few examples. In some embodiments, media device 106 can be a part of, integrated with, operatively coupled to, and/or connected to its respective display device 108. In some embodiments, image capturing device 134 may be operatively coupled to, and/or connected to media system 104 and communicate to content server(s) 120 and/or system server(s) 126 via media system 104. In some aspects, image-capturing device 134 may communicate directly with content server(s) 120 and/or system server(s) 126 without needing to communicate via media system 104.

Each media device 106 may be configured to communicate with network 118 via a communication device 114. Communication device 114 may include, for example, a cable modem or satellite TV transceiver. Media device 106 may communicate with communication device 114 over a link 116, wherein link 116 may include wireless (such as Wi-Fi) and/or wired connections.

In various embodiments, network 118 can include, without limitation, wired and/or wireless intranet, extranet, Internet, cellular, Bluetooth, infrared, and/or any other short range, long range, local, regional, global communications mechanism, means, approach, protocol and/or network, as well as any combination(s) thereof.

Media system 104 may include a remote control 110. Remote control 110 can be any component, part, apparatus and/or method for controlling media device 106 and/or display device 108, such as a remote control, a tablet, laptop computer, smartphone, wearable, on-screen controls, integrated control buttons, audio controls, or any combination thereof, to name just a few examples. In an embodiment, remote control 110 wirelessly communicates with media device 106 and/or display device 108 using cellular, Bluetooth, infrared, etc., or any combination thereof. Remote control 110 may include a microphone 112, which is further described below.

Multimedia environment 102 may include a plurality of content servers 120 (also called content providers, channels or sources). Although only one content server 120 is shown in FIG. 1, in practice multimedia environment 102 may include any number of content servers 120. Each content server of content servers 120 may be configured to communicate with network 118.

In some embodiments, stochastic multi-period multi-objective optimization (MPMOO) based recommendation system may be implemented in multimedia environment 102 for generating program recommendations between content servers 120 and a plurality of media devices, including media device 106, which can more efficient communications within multimedia environment 102. Using stochastic boosting techniques to distribute random boosted content recommendations between the plurality of media devices in multimedia environment 102, which improves load balancing and bandwidth optimization of content requests to content servers 120. This is because content requests based on the recommendations will generally be varied across different content (rather than being directed to only popular content). As a result, content requests can be balanced between content servers 120 which reduces demand on the content servers 120, allowing more content to be cached efficiently at content servers 120.

Each content server of content servers 120 may store content 122 and metadata 124. Content 122 may include any combination of music, videos, movies, TV programs, multimedia, images, still pictures, text, graphics, gaming applications, advertisements, programming content, public service content, government content, local community content, software, and/or any other content or data objects in electronic form.

In some embodiments, metadata 124 comprises data about content 122. For example, metadata 124 may include associated or ancillary information indicating or related to writer, director, producer, composer, artist, actor, summary, chapters, production, history, year, trailers, alternate versions, related content, applications, and/or any other information pertaining or relating to content 122. Metadata 124 may also or alternatively include links to any such information pertaining or relating to content 122. Metadata 124 may also or alternatively include one or more indexes of content 122.

Multimedia environment 102 may include one or more system servers 126. System servers 126 may operate to support media devices 106 from the cloud. It is noted that the structural and functional aspects of system servers 126 may wholly or partially exist in the same or different ones of system servers 126.

The media devices 106 may exist in thousands or millions of media systems 104. Accordingly, the media devices 106 may lend themselves to crowdsourcing embodiments and, thus, the system servers 126 may include one or more crowdsource servers 128.

For example, using information received from the media devices 106 in the thousands and millions of media systems 104, the crowdsource server(s) 128 may identify similarities and overlaps between closed captioning requests issued by different users 132 watching a particular movie. Based on such information, the crowdsource server(s) 128 may determine that turning closed captioning on may enhance users'viewing experience at particular portions of the movie (for example, when the soundtrack of the movie is difficult to hear), and turning closed captioning off may enhance users'viewing experience at other portions of the movie (for example, when displaying closed captioning obstructs critical visual aspects of the movie). Accordingly, the crowdsource server(s) 128 may operate to cause closed captioning to be automatically turned on and/or off during future streaming of the movie.

The system servers 126 may also include an audio command processing module 130. As noted above, remote control 110 may include microphone 112. Microphone 112 may receive audio data from users 132 (as well as other sources, such as the display device 108). In some embodiments, media device 106 may be audio responsive, and the audio data may represent verbal commands from user 132 to control media device 106 as well as other components in media system 104, such as display device 108.

In some embodiments, the audio data received by microphone 112 in remote control 110 is transferred to media device 106, which then forwards the audio data to audio command processing module 130 in system servers 126. Audio command processing module 130 may operate to process and analyze the received audio data to recognize a verbal command of user 132. Audio command processing module 130 may then forward the verbal command back to media device 106 for processing.

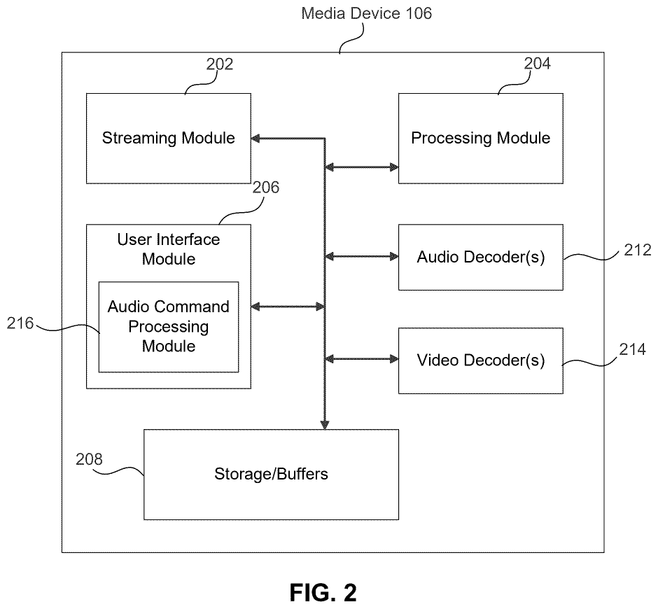

In some embodiments, the audio data may be alternatively or additionally processed and analyzed by an audio command processing module 216 in media device 106 (see FIG. 2). Media device 106 and system servers 126 may then cooperate to pick one of the verbal commands to process (either the verbal command recognized by audio command processing module 130 in system servers 126, or the verbal command recognized by audio command processing module 216 in media device 106).

FIG. 2 illustrates a block diagram of an example media device 106, according to some embodiments. Media device 106 may include a streaming module 202, a processing module 204, storage/buffers 208, and a user interface module 206. As described above, user interface module 206 may include audio command processing module 216.

Media device 106 may also include one or more audio decoders 212 and one or more video decoders 214.

Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OP1a, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to H.263, H.264, H.265, AVI, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

Streaming module 202 of media device 106 may be configured to receive image information from image capturing device 134. In some aspects, the image information may comprise LECI frame generated by a low-power processor of the image-capturing device 134. In some aspects, the image information may comprise a sequence of image frames recorded by the image-capturing device 134 and an indication (e.g., a flag, a bit in a header of a packet) that the media device 106 can generate a LECI frame from the provided image information. For example, processing module 204 may receive the sequence of image frames from image capturing device 134 and generate a LECI frame from the provided sequence. In this manner, image-capturing device 134 may offload LECI processing to the media device 106. For example, image-capturing device 134 may determine it lacks sufficient processing power or electrical power (e.g., a low battery) to generate LECI frames and, instead, transmits the recorded sequence of image frames to media device 106.

Now referring to both FIGS. 1 and 2, in some embodiments, user 132 may interact with media device 106 via, for example, remote control 110. For example, user 132 may use remote control 110 to interact with user interface module 206 of media device 106 to select a content item, such as a movie, TV show, music, book, application, game, etc. In response to the user selection, streaming module 202 of media device 106 may request the selected content item from content server(s) 120 over network 118. Content server(s) 120 may transmit the requested content item to streaming module 202. Media device 106 may transmit the received content item to display device 108 for playback to user 132.

In some aspects, media device 106 may display an interface for interacting with the sequence of image frames provided by image capturing device 134. For example, the interface may display selectable options for generating LECI frames based on the sequence of image frames. One example of a selectable option is the duration of time (e.g., 1 minute, 5 minutes) of the sequence of images for which to generate the LECI images. Another example includes the types of annotations or effects (e.g., arrows, heat maps, highlighting, blurring) to be added to the LECI to represent actions or objects detected within the frames of the sequence of frames.

In streaming embodiments, streaming module 202 may transmit the content item to display device 108 in real time or near real time as it receives such content item from content server(s) 120. In non-streaming embodiments, media device 106 may store the content item received from content server(s) 120 in storage/buffers 208 for later playback on display device 108.

Stochastic multi-period multi-objective optimization based recommendation system

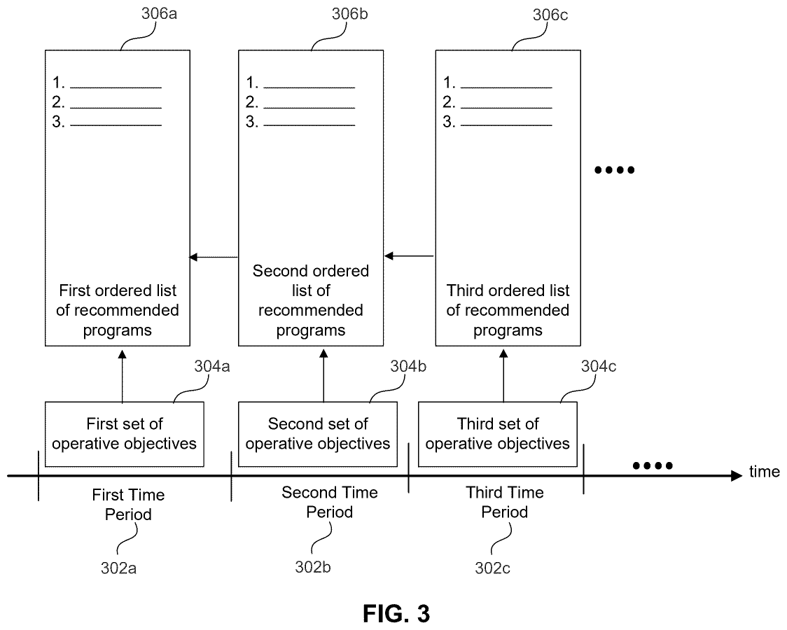

FIG. 3 illustrates an example GUI displaying ordered lists of recommended programs generated by a stochastic multi-period multi-objective optimization (MPMOO) based recommendation system over multiple time periods, according to some aspects of this disclosure. According to some aspects, content recommendation system can be implemented by content servers 120 or system server(s) 126 and can be configured to communicate with media system 104 in multimedia environment 102 of FIG. 1.

According to some aspects, the content recommendation systems can be configured to generate recommendations that optimize a designated set of recommendation objectives. The designated set of recommendation objectives can include maximizing user engagement, maximizing watch time, maximizing click-through rates for video recommendations, maximizing user satisfaction or relevance, maximizing long-term user retention, revenue maximization, minimizing content fatigue, bias mitigation, and/or the like. According to some aspects, a stochastic MPMOO based recommendation system can use a different objective function for each time period of operation, instead of using a single objective function over multiple time periods.

The example of FIG. 3 illustrates generating ordered lists of recommended programs 306a-306c over three consecutive time periods 302a-302c. According to some aspects, the stochastic MPMOO based recommendation system selects a set of operative objectives 304a-304c for each time period of operation 302a-302c. The stochastic MPMOO based recommendation system then generates ordered lists of recommended programs 306a-306c based on the sets of operative recommendation objectives 304a-304c.

According to some aspects, the stochastic MPMOO based recommendation system can select a subset of recommendation objectives from the designated set of recommendation objectives as the operative objectives for a given time period of operation. The recommendation objectives, from the set of designated recommendation objectives which are not selected to be the operative recommendation objectives are designated as non-operative recommendaiton objectives for that time period of operation. Furthermore, the objective function used by the stochastic MPMOO based recommendation system is based on the selected operative recommendation objectives, and the non-operative recommendation objectives are not included in the objective function. According to some aspects, the operative recommendation objectives for a given time period of operation can be selected from a set of non-operative recommendation objectives corresponding to a previous time period of operation.

According to some aspects, a stochastic parameter can be assigned to each recommendation objective of the designated set of recommendation objectives. The operative recommendation objectives for each time period can be selected from the designated set of recommendation objectives based on the assigned stochastic parameters. According to some aspects, a stochastic parameter associated with a recommendation objective can be an independent randomly generated rational number between 0 and 1. According to some aspects, all stochastic parameters assigned to the designated set of recommendation objectives can be random variables that are identically distributed. Furthermore, the values taken by a stochastic parameter over each time period can be independent. According to some aspects, the value of a stochastic parameter can indicate the probability that the corresponding recommendation objective is selected as an operative objective during the given time period. According to some aspects, when the value of a stochastic parameter exceeds a threshold value, the corresponding recommendation objective can be selected as an operative objective during the given time period.

According to some aspects, a time period can be a predefined duration of time determined by the recommendation system. Each user session may include multiple time periods. Alternatively, a time period may be defined as an extended period of time (e.g., multiple hours or days) and a single time period may include several user sessions.

According to some aspects, content 122 stored at content server of content servers 120 may include several programs of different types. According to some aspects, the set of programs available at content server of content servers 120 can include multimedia content such as music, videos, movies, TV programs, multimedia, gaming applications, advertisements, programming content, public service content, government content, local community content, software, and/or the like. According to some aspects, each program, can be associated with specific recommendation objectives based on the programs type and relevance and the multimedia platform's priorities, user behavior, and business model. According to some aspects, each program of content 122 can be associated with one or more recommendation objectives. For example, highly relevant or trending movies or TV shows can be associated with recommendaiton objectives such as maximizing user engagement, maximizing user retention, and/or the like. Advertisements, sponsored content, e-commence product recommendations, and the like can be associated with recommendation objectives such as maximizing revenue.

According to some aspects, the association between the set of programs available at content server of content servers 120 and the recommendation objectives can be specific to a user profile, and the recommendation objectives associated with each program can depend on the known preferences of the user.

According to some aspects, for each time period, the stochastic MPMOO based recommendation system generates an ordered list of recommended programs. For a given time period, an ordered list of recommended programs can be generated based on the operative recommendation objectives selected for the given time period and the recommendation objectives associated with each program. According to some aspects, an ordered list of recommended programs can be generated using a rank boost approach, where the rank assigned a program associated with one or more operative recommendation objectives is boosted. Alternatively, or additionally, an ordered list of recommended programs can be generated based on a stochastic cumulative score assigned to each program based on one or more operative recommendation objectives associated with the program.

According to some aspects, using the rank-boost approach, when a program is associated with one or more operative objectives, the stochastic MPMOO based recommendation system can boost the rank of the program by a boost-factor that is inversely proportional to the current rank of the program in an existing ordered list (e.g., the boost-factor applied to a lower ranked program is higher than the boost-factor applied to a higher ranked program). As an example, consider an existing ordered list of recommended programs in which only three programs, programs A, B, and C, are each associated with one or more operative recommendation objectives during a given time period. According to some aspects, assuming programs A, B, and C are ranked 4, 7, and 9, respectively, in the existing ordered list of recommended programs, with the rank-boost approach, the boost factors applied to the programs A, B, and C can be 3, 5, and 8, respectively. Once the boost-factors are applied, programs A, B, and C can be ranked 1, 2, and 3, respectively, and the rank of each of the rest of the programs in the existing ordered list of recommended programs can be reduced by 3. According to some aspects, the boost-factor applied to a program associated with one or more operative recommendation objectives during a given time period can be proportional to [1/(rank_p+1)], where rank_p is the rank of the program in an existing ordered list of recommended programs. According to some aspects, the applied stochastic boost factors can be user-dependent, and different users may use different boost factors.

According to some aspects, an ordered list of recommended programs can be generated based on a stochastic cumulative score assigned to each program of content 122. According to some aspects, one or more operative recommendation objective can be associated with the program. According to some aspects, each operative recommendation objectives for a given time period can be assigned a weight. The weight assigned to each recommendation objective can dynamically change for each time period based on the computational or data resources allocated to each of the recommendation objectives.

According to some aspects, when a program is associated with one or more operative recommendation objectives, a stochastic cumulative score can be computed based on the weights of the associated operative recommendation objective. According to some aspects, the stochastic MPMOO based recommendation system identifies the programs that are associated with one or more operative recommendation objectives from the set of programs of content 122. For each program that is associated with one or more operative recommendation objectives, a stochastic cumulative score can be computed based on the weights of the associated operative recommendation objective. The stochastic MPMOO based recommendation system then sorts the programs based on the stochastic cumulative scores to generate the ordered list of recommended programs.

According to some aspects, the stochastic MPMOO based recommendation system can dynamically reorganize the programs displayed on a GUI of a user based on the generated ordered lists of recommended programs. Dynamically reorganizing the display of programs on a GUI based on the ordered lists of recommended programs allows the content recommendation system to continuously adapt and deliver a seamless user experience.

According to some aspects, using stochastic MPMOO based recommendation system to generate the ordered list of recommended programs enables balancing conflicting recommendation objectives over time. Also, since stochastic MPMOO based recommendation systems optimize a limited number of recommendation objectives over each time period of operation, they do not experience scalability issues. Furthermore, stochastic MPMOO based recommendation system can improve the overall utilization of network resources by dynamically adjusting to varying user demands, traffic patterns, and content types, resulting in a more balanced network resource allocation.

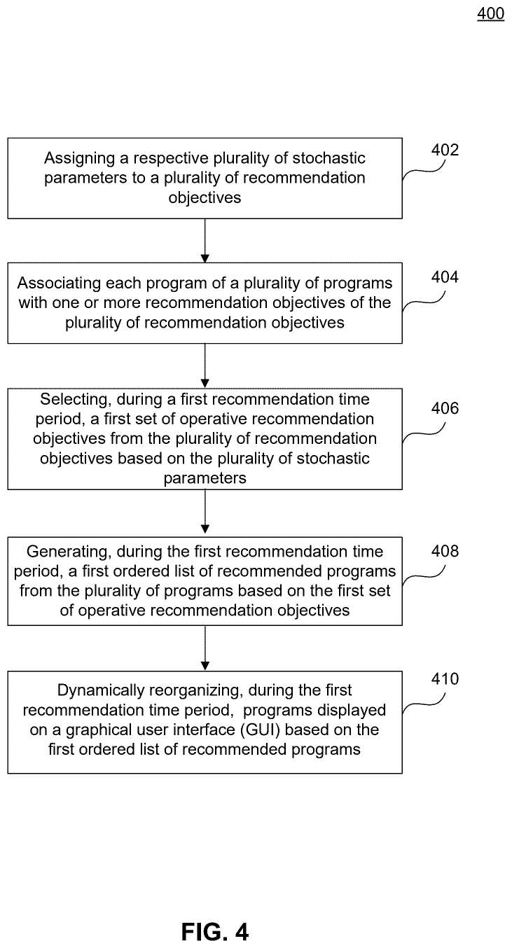

FIG. 4 is a flow diagram of a method 400 for generating ordered lists of recommended programs using a stochastic multi-period multi-objective optimization (MPMOO) based recommendation system, according to some embodiments. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art.

Method 400 shall first be described with reference to the example embodiment of generating an ordered list of recommended programs, depicted in FIG. 3, although method 400 is not limited to that embodiment.

In 402, the stochastic MPMOO based recommendation system assigns a respective plurality of stochastic parameters to a plurality of recommendation objectives. Using a stochastic MPMOO approach for generating program recommendations enables improved network performance and resource management compared to using a deterministic optimization approach. As an example, when using a stochastic MPMOO based recommendation system, user requests, which are generated in response to the recommended programs, can be distributed over a wider range of content to reduce demand on caches, allowing more content to be cached efficiently which improves cache hit rates and reducing server load at content servers 120. According to some aspects, a stochastic parameter associated with a recommendation objective can be an independent randomly generated rational number between 0 and 1 for each time period.

In 404, the stochastic MPMOO based recommendation system associates each program of a plurality of programs with one or more recommendation objectives of the plurality of recommendation objectives. According to some aspects, each program of content 122, can be associated with specific recommendation objectives based on the programs type and relevance and the multimedia platform's priorities, user behavior, and business model. According to some aspects, each program can be associated with one or more recommendation objectives. According to some aspects, the association between the set of programs available at content server of content servers 120 and the recommendation objectives can be specific to a user profile, and the recommendation objectives associated with each program can depend on the known preferences of the user. According to some aspects, the distribution of the stochastic parameters assigned to the recommendation objectives and the associations between various programs and recommendation objectives can be adjusted based on contextual factors. For example, contextual factors such as current time, user viewing habits, user location, specific events, may be incorporated into the stochastic MPMOO system for dynamically adjusting content delivery, making the system more adaptive and responsive to user behavior or network conditions.

In 406, the stochastic MPMOO based recommendation system selects, during a first recommendation time period, a first set of operative recommendation objectives from the plurality of recommendation objectives based on the plurality of stochastic parameters. The operative recommendation objectives for each time period can be selected from the designated set of recommendation objectives based on the assigned stochastic parameters.

According to some aspects, the value of a stochastic parameter can indicate the probability that the corresponding recommendation objective is selected as an operative objective during the given time period. According to some aspects, when the value of a stochastic parameter exceeds a threshold value, the corresponding recommendation objective can be selected as an operative objective during the given time period. As a non-limiting example, the plurality of recommendation objectives can consist of objectives maximizing user engagement and revenue maximization, and the stochastic parameters assigned to the objectives maximizing user engagement and revenue maximization can be assigned values of 1 and 0.5, respectively. Since the recommendation objectives are selected independently of each other, both objectives of maximizing user engagement and revenue maximization are selected as operative objectives with a probability of 0.5. Furthermore, the probability that maximizing user engagement is selected as the only operative objective is 0.5, and the probability that revenue maximization is selected as the only operative objective is 0.

According to some aspects, the recommendation objectives, from the set of designated recommendation objectives that are not selected to be the operative recommendation objectives are designated as non-operative recommendation objectives for that time period of operation. Furthermore, the objective function used by the stochastic MPMOO based recommendation system is based on the selected operative recommendation objectives, and the non-operative recommendation objectives are not included in the objective function. According to some aspects, the operative recommendation objectives for a given time period of operation can be selected from a set of non-operative recommendation objectives corresponding to a previous time period of operation.

In 408, the stochastic MPMOO based recommendation system generates, during the first recommendation time period, a first ordered list of recommended programs from the plurality of programs based on the first set of operative recommendation objectives. For a given time period, an ordered list of recommended programs can be generated based on the operative recommendation objectives selected for the given time period and the recommendation objectives associated with each program. According to some aspects, an ordered list of recommended programs can be generated using a rank boost approach, where the rank assigned to a program associated with one or more operative recommendation objectives is boosted. Alternatively, or additionally, an ordered list of recommended programs can be generated based on a stochastic cumulative score assigned to each program based on one or more operative recommendation objectives associated with the program.

According to some aspects, stochastic MPMOO based recommendation systems using stochastic boosting or stochastic cumulating scoring to generate ordered lists of recommended programs can improve load balancing and bandwidth optimization between media systems 104 and content servers 120. Where a deterministic approach can cause user requests to be concentrated on popular content (leading to uneven loads across the content delivery system), stochastic boosting can improve the ability of the system to distribute user requests across different content servers, which can reduce network latency. This can also result in content requests being directed across the content delivery system, instead of at specific servers, which can optimize bandwidth usage between media systems 104 and content servers 120.

In 410, the stochastic MPMOO based recommendation system dynamically reorganizes programs displayed on a graphical user interface (GUI) based on the first ordered list of recommended programs. Dynamically reorganizing the display of programs on a GUI based on the ordered lists of recommended programs allows the content recommendation system to continuously adapt and deliver a seamless user experience.

According to some aspects, the stochastic MPMOO based recommendation system selects, during a second recommendation time period, a second set of operative recommendation objectives from the plurality of recommendation objectives based on the plurality of stochastic parameters.

According to some aspects, the stochastic MPMOO based recommendation system generates, during the second recommendation time period, a second ordered list of recommended programs from the plurality of programs based on the second set of operative recommendation objectives. The stochastic MPMOO based recommendation system can dynamically reorganize programs displayed on the GUI based on the second ordered list of recommended programs.

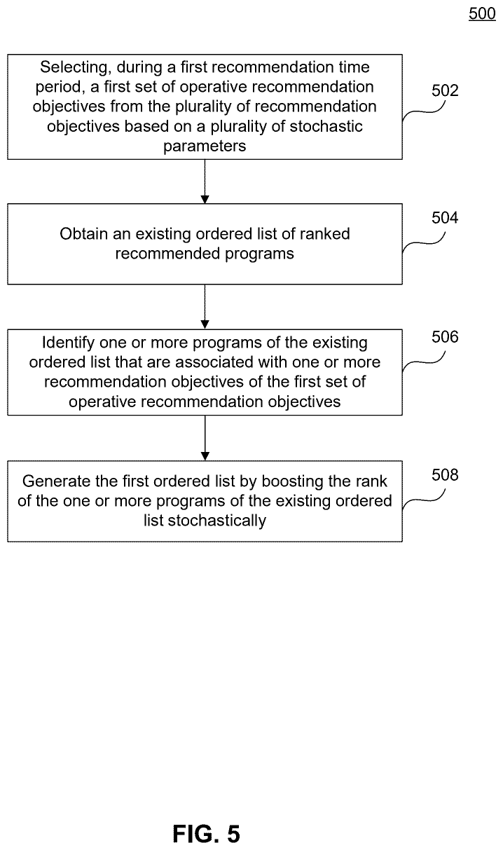

FIG. 5 is a flow diagram of method 500 for generating an ordered list of recommended programs using a stochastic multi-period multi-objective optimization (MPMOO) based recommendation system with stochastic rank boosting, according to some embodiments. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously or in a different order than shown in FIG. 5, as will be understood by a person of ordinary skill in the art.

Method 500 shall first be described with reference to the example embodiment of generating an ordered list of recommended programs, depicted in FIG. 3, although method 500 is not limited to that embodiment.

In 502, the stochastic MPMOO based recommendation system selects during a first recommendation time period, a first set of operative recommendation objectives from the plurality of recommendation objectives based on a plurality of stochastic parameters. The recommendation objectives, from the plurality of recommendation objectives that are not selected to be the operative recommendation objectives are designated as non-operative recommendation objectives for that time period of operation. Furthermore, the objective function used by the stochastic MPMOO based recommendation system is based on the selected operative recommendation objectives, and the non-operative recommendation objectives are not included in the objective function.

In 504, the stochastic MPMOO based recommendation system obtains an existing ordered list of ranked recommended programs. According to some aspects, for a given time period, an existing ordered list of ranked recommended programs can be an ordered list of recommended programs from one of the earlier time periods.

In 506, the stochastic MPMOO based recommendation system identifies one or more programs from the existing ordered list that are associated with one or more recommendation objectives of the first set of operative recommendation objectives. According to some aspects, each program of content 122 can be associated with one or more recommendation objectives.

In 508, the stochastic MPMOO based recommendation system generates the first ordered list by boosting the rank of the one or more programs of the existing ordered list stochastically. According to some aspects, using the rank-boost approach, when a program is associated with one or more operative objectives, the stochastic MPMOO based recommendation system can boost the rank of the program by a boost-factor that is inversely proportional to the current rank of the program in an existing ordered list (e.g., the boost-factor applied to a lower ranked program is higher than the boost-factor applied to a higher ranked program). According to some aspects, the stochastic MPMOO based recommendation system dynamically reorganizes programs displayed on a GUI based on the first ordered list of recommended programs.

According to some aspects, using stochastic MPMOO based recommendation systems with stochastic boosting to generate ordered lists of recommended programs can improve load balancing and bandwidth optimization. Furthermore, stochastic boosting can improve the ability of the system to distribute user requests across different content servers which can reduce network latency. Stochastically boosting the rank of one or more programs can also result in content requests being directed across the content delivery system, instead of at specific servers, which can optimize bandwidth usage. According to some aspects, the applied stochastic boost factors can be user-dependent, and different users may use different boost factors.

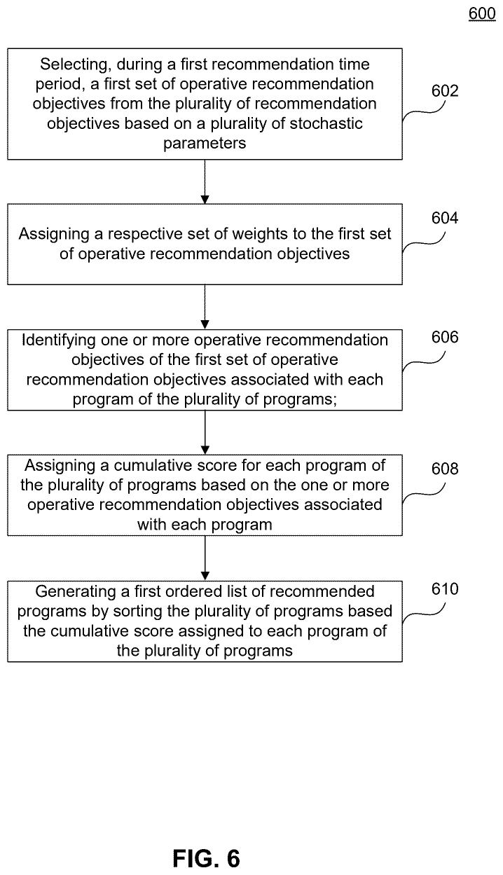

FIG. 6 is a flow diagram of method 600 for generating an ordered list of recommended programs using a stochastic multi-period multi-objective optimization (MPMOO) based recommendation system with ranking based on a stochastic cumulative score, according to some embodiments. Method 600 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously or in a different order than shown in FIG. 6, as will be understood by a person of ordinary skill in the art.

Method 600 shall first be described with reference to the embodiment of system 300 for offline training of an ICRS, depicted in FIGS. 3 and 4, although method 500 is not limited to those embodiments.

In 602, the stochastic MPMOO based recommendation system selects, during a first recommendation time period, a first set of operative recommendation objectives from the plurality of recommendation objectives based on a plurality of stochastic parameters. The operative recommendation objectives for each time period can be selected from the designated set of recommendation objectives based on the assigned stochastic parameters. According to some aspects, the value of a stochastic parameter can indicate the probability that the corresponding recommendation objective is selected as an operative objective during the given time period. According to some aspects, when the value of a stochastic parameter exceeds a threshold value, the corresponding recommendation objective can be selected as an operative objective during the given time period.

As a non-limiting example, the plurality of recommendation objectives can consist of objectives A and B and the stochastic parameters assigned to objectives A and B can be P_{A} and P_{B}, respectively. Stochastic parameter P_{A} can indicate the probability that objective A is selected as an operative objective during the given time period. Similarly, the stochastic parameter P_{B} can indicate the probability that objective B is selected as an operative objective during the given time period. Assuming P_{A}=0.5 and P_{B}=0.5, the probability that only objective A is selected as an operative objective is P_{A}(1-P_{B})=0.5, and the probability that only objective B is selected as an operative objective is P_{B}(1-P_{A})=0.5. Furthermore, the probability that both objective A and objective B are selected as operative objectives is P_{A} P_{B}=0.25, and the probability that neither objective A nor objective B are selected as operative objectives is (1-P_{A})(1-P_{B})=0.25. As another example, if the objectives of maximizing user engagement and revenue maximization are assigned stochastic parameter values of 1 and 0.5, respectively, both the objectives are selected as operative objectives with a probability of 0.5.

In 604, the stochastic MPMOO based recommendation system assigns a respective set of weights to the first set of operative recommendation objectives. According to some aspects, each operative recommendation objective for a given time period can be assigned a weight. The weight assigned to an each recommendation objective can dynamically change for each time period based on the computational or data resources allocated to each of the recommendation objectives.

In 606, the stochastic MPMOO based recommendation system identifies one or more operative recommendation objectives of the first set of operative recommendation objectives associated with each program of the plurality of programs.

In 608, the stochastic MPMOO based recommendation system assigns a stochastic cumulative score for each program of the plurality of programs based on one or more operative recommendation objectives associated with each program. According to some aspects, for each program that is associated with one or more operative recommendation objectives, a stochastic cumulative score can be computed based on the weights of the associated operative recommendation objective.

In 610, the stochastic MPMOO based recommendation system generates a first ordered list of recommended programs by sorting the plurality of programs based on the stochastic cumulative score assigned to each program of the plurality of programs. According to some aspects, the stochastic MPMOO based recommendation system dynamically reorganizes programs displayed on a GUI based on the first ordered list of recommended programs.

### Example Computer System

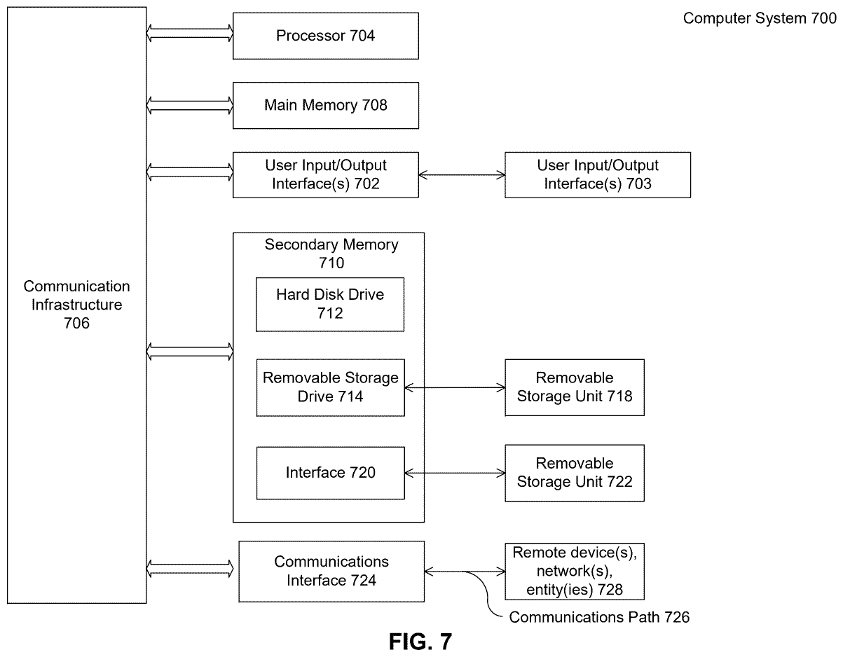

Various embodiments may be implemented, for example, using one or more well-known computer systems, such as computer system 700 shown in FIG. 7. For example, the media device 106 may be implemented using combinations or sub-combinations of computer system 700. Also or alternatively, one or more computer systems 700 may be used, for example, to implement any of the embodiments discussed herein, as well as combinations and sub-combinations thereof. Computer system 700 may include one or more processors (also called central processing units, or CPUs), such as a processor 704. Processor 704 may be connected to a communication infrastructure or bus 706.

Computer system 700 may also include user input/output device(s) 703, such as monitors, keyboards, pointing devices, etc., which may communicate with communication infrastructure 706 through user input/output interface(s) 702.

One or more of processors 704 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 may also include a main or primary memory 708, such as random access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 may include a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 may read from and/or write to removable storage unit 718.

Secondary memory 710 may include other means, devices, components, instrumentalities or other approaches for allowing computer programs and/or other instructions and/or data to be accessed by computer system 700. Such means, devices, components, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. (individually and collectively referenced by reference number 728). For example, communication interface 724 may allow computer system 700 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700 or processor(s) 704), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

### Conclusion

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method for stochastic multi-period multi-objective optimization based recommendation systems, comprising:
assigning, by at least one computer processor, a respective plurality of stochastic parameters to a plurality of recommendation objectives;
associating each program of a plurality of programs with one or more recommendation objectives of the plurality of recommendation objectives;
selecting, during a first recommendation time period, a first set of operative recommendation objectives from the plurality of recommendation objectives based on the plurality of stochastic parameters;
generating, during the first recommendation time period, a first ordered list of recommended programs from the plurality of programs based on the first set of operative recommendation objectives; and
dynamically reorganizing, during the first recommendation time period, programs displayed on a graphical user interface (GUI) based on the first ordered list of recommended programs.

2. The method of claim 1, further comprises:
selecting, during a second recommendation time period, a second set of operative recommendation objectives from the plurality of recommendation objectives based on the plurality of stochastic parameters; and
generating, during the second recommendation time period, a second ordered list of recommended programs from the plurality of programs based on the second set of operative recommendation objectives.

3. The method of claim 1, wherein the generating the first ordered list of recommended programs further comprises:
obtaining an existing ordered list of ranked recommended programs;
identifying one or more programs of the existing ordered list that are associated with one or more recommendation objectives of the first set of operative recommendation objectives;
generating the first ordered list by boosting the rank of the one or more programs of the existing ordered list.

4. The method of claim 3, wherein the boosting the rank of the one or more programs is performed using a reciprocal ranking technique.

5. The method of claim 1, wherein the generating the first ordered list of recommended programs further comprises:
assigning a respective set of weights to the first set of operative recommendation objectives;
identifying one or more operative recommendation objectives of the first set of operative recommendation objectives associated with each program of the plurality of programs;
assigning a stochastic cumulative score for each program of the plurality of programs based on the one or more operative recommendation objectives associated with each program of the plurality of programs;
generating the first ordered list by sorting the plurality of programs based the stochastic cumulative score assigned to each program of the plurality of programs.

6. The method of claim 5, wherein the stochastic cumulative score for each program is a weighted average score.

7. The method of claim 1, wherein a stochastic parameter of the plurality of stochastic parameters associated with a recommendation objective of the plurality of recommendation objectives determines the probability that the recommendation objective is selected as an operative recommendation objective during the respective recommendation time period.

8. The method of claim 1, wherein the plurality of recommendation objectives include one or more of the following: user engagement, revenue, click-through rate, program play rate, and program streaming time.

9. A system, comprising:
a memory; and
one or more processors coupled to the memory and configured to:
assign a respective plurality of stochastic parameters to a plurality of recommendation objectives;
associate each program of a plurality of programs with one or more recommendation objectives of the plurality of recommendation objectives;
select, during a first recommendation time period, a first set of operative recommendation objectives from the plurality of recommendation objectives based on the plurality of stochastic parameters;
generate, during the first recommendation time period, a first ordered list of recommended programs from the plurality of programs based on the first set of operative recommendation objectives; and
dynamically reorganize, during the first recommendation time period, programs displayed on a graphical user interface (GUI) based on the first ordered list of recommended programs.

10. The system of claim 9, wherein the one or more processor are further configured to:
select, during a second recommendation time period, a second set of operative recommendation objectives from the plurality of recommendation objectives based on the plurality of stochastic parameters; and
generate, during the second recommendation time period, a second ordered list of recommended programs from the plurality of programs based on the second set of operative recommendation objectives.

11. The system of claim 9, wherein to generate the first ordered list of recommended programs, the one or more processor are further configured to:
obtain an existing ordered list of ranked recommended programs;
identify one or more programs of the existing ordered list that are associated with one or more recommendation objectives of the first set of operative recommendation objectives;
generate the first ordered list by boosting the rank of the one or more programs of the existing ordered list.

12. The system of claim 11, wherein the boosting the rank of the one or more programs is performed using a reciprocal ranking technique.

13. The system of claim 9, wherein to generate the first ordered list of recommended programs, the one or more processor are further configured to:
assign a respective set of weights to the first set of operative recommendation objectives;
identify one or more operative recommendation objectives of the first set of operative recommendation objectives associated with each program of the plurality of programs;
assign a stochastic cumulative score for each program of the plurality of programs based on the one or more operative recommendation objectives associated with each program of the plurality of programs;
generate the first ordered list by sorting the plurality of programs based the stochastic cumulative score assigned to each program of the plurality of programs.

14. The system of claim 13, wherein the stochastic cumulative score for each program is a weighted average score.

15. The system of claim 9, wherein a stochastic parameter of the plurality of stochastic parameters associated with a recommendation objective of the plurality of recommendation objectives determines the probability that the recommendation objective is selected as an operative recommendation objective during the respective recommendation time period.

16. A non-transitory computer-readable medium having instructions stored thereon that, when executed by at least one computing device, cause the at least one computing device to perform operations comprising:
assigning, by at least one computer processor, a respective plurality of stochastic parameters to a plurality of recommendation objectives;
associating each program of a plurality of programs with one or more recommendation objectives of the plurality of recommendation objectives;
selecting, during a first recommendation time period, a first set of operative recommendation objectives from the plurality of recommendation objectives based on the plurality of stochastic parameters;
generating, during the first recommendation time period, a first ordered list of recommended programs from the plurality of programs based on the first set of operative recommendation objectives; and
dynamically reorganizing, during the first recommendation time period, programs displayed on a graphical user interface (GUI) based on the first ordered list of recommended programs.

17. The non-transitory computer-readable medium of claim 16, wherein the operations further comprises:
selecting, during a second recommendation time period, a second set of operative recommendation objectives from the plurality of recommendation objectives based on the plurality of stochastic parameters; and
generating, during the second recommendation time period, a second ordered list of recommended programs from the plurality of programs based on the second set of operative recommendation objectives.

18. The non-transitory computer-readable medium of claim 16, wherein the generating the first ordered list of recommended programs comprises:
obtaining an existing ordered list of ranked recommended programs;
identifying one or more programs of the existing ordered list that are associated with one or more recommendation objectives of the first set of operative recommendation objectives;
generating the first ordered list by boosting the rank of the one or more programs of the existing ordered list.

19. The non-transitory computer-readable medium of claim 16, wherein the generating the first ordered list of recommended programs comprises:
assigning a respective set of weights to the first set of operative recommendation objectives;
identifying one or more operative recommendation objectives of the first set of operative recommendation objectives associated with each program of the plurality of programs;
assigning a stochastic cumulative score for each program of the plurality of programs based on the one or more operative recommendation objectives associated with each program of the plurality of programs;
generating the first ordered list by sorting the plurality of programs based the stochastic cumulative score assigned to each program of the plurality of programs.

20. The non-transitory computer-readable medium of claim 16, wherein a stochastic parameter of the plurality of stochastic parameters associated with a recommendation objective of the plurality of recommendation objectives determines the probability that the recommendation objective is selected as an operative recommendation objective during the respective recommendation time period.
